(19) United States
(12) Patent Application Publication
(10) Pub. No.: US 2022/0010585 A1
(43) Pub. Date: Jan. 13, 2022

(54) DUAL-PURPOSE FOOT-OPERATED DOOR OPENER

(71) Applicant: GREATIM INTERNATIONAL INC., Taipei City (TW)

(72) Inventor: SHENG-CHUN LIN, Taipei City (TW)

(73) Assignee: GREATIM INTERNATIONAL INC., Taipei City (TW)

(21) Appl. No.: 17/317,364

(22) Filed: May 11, 2021

(30) Foreign Application Priority Data
Jul. 9, 2020 (TW) 109208753

(51) Int. Cl. E05B 1/00

(52) U.S. Cl. CPC E05B 1/0015

(57) ABSTRACT

A dual-purpose foot-operated door opener adapted to be fixed on an inward surface of a door. The foot-operated door opener has a fixed portion and an upper hook portion. The fixed portion is fixed on the inward surface of the door and has an upper end and a lower end. The upper hook portion is connected to the upper end of the fixed portion. The lower hook portion is connected to the lower end of the fixed portion and extends away from the door. A distal area of the lower hook portion is bent upward. The door can be pulled open either by putting the tiptoes of a foot into the upper hook to hook the upper hook portion or by pressing the foot on the lower hook portion to frictionally engage the foot with the lower hook portion.

### BACKGROUND OF THE INVENTION

### 1. Field of the Invention

The present invention relates to a door hardware, especially to a door opener that is mounted to the bottom of a door and enables a user to open the door by foot.

### 2. Description of the Prior Arts

A conventional foot-operated door opener such as the press-pull hygiene door opener disclosed in U.S. Pat. No. 9,115,530B2 has a mounting plate, an extension portion and a protrusion. The mounting plate is fixed to a bottom edge of an inward surface of a door. The inward surface of the door is defined as the surface of the door facing toward a direction in which the door swings open. The extension portion is a plate fixed to the mounting plate. The protrusion protrudes from a distal end of the extension portion. A user presses down the extension portion with his foot so that the bottom of the shoe abuts against the protrusion to generate friction. Then, the user can retract his foot toward his body to pull the door open.

However, the conventional foot-operated door opener can only be operated by press the foot on the protrusion, and therefore is inoperable when the user is incapable of pressing down his foot due to reasons such as injury on the sole.

Moreover, the protrusion is a plate extending upward so that the bottom of the shoe abuts against an edge of the protrusion. Contact between the shoe and the protrusion is merely a narrow linear surface which is much smaller than a total area of the bottom of the shoe. As a result, the friction generated by the shoe abutting against the protrusion is limited, and the foot is likely to slip on the protrusion when pulling open the door.

To overcome the shortcomings, the present invention provides a dual-purpose foot-operated door opener to mitigate or obviate the aforementioned problems.

### SUMMARY OF THE INVENTION

The main objective of the present invention is to provide a dual-purpose foot-operated door opener that facilitates a user to pull a door open by abutting instep of a foot against an upper hook portion or stepping on the lower hook portion and then retracting the foot to pull the door open.

The dual-purpose foot-operated door opener is adapted to be fixed on an inward surface of a door. The foot-operated door opener has a fixed portion and an upper hook portion. The fixed portion is fixed on the inward surface of the door and has an upper end and a lower end. The upper hook portion is connected to the upper end of the fixed portion. The lower hook portion is connected to the lower end of the fixed portion, extends away from the door, and is bent upward.

When in use, a door having the present invention can be opened in two ways. The first way is to put the tiptoes of a foot into the upper hook portion via the upper hook opening and abut instep of the foot against an inner surface of the upper hook portion to hook the upper hook portion. Then the user can retract the foot toward his body to pull the door open by the upper hook portion. The second way is to press the sole of the foot on the lower hook portion to frictionally engage the foot with the lower hook portion. Then the user can retract his foot to pull the door open.

The advantage of the present invention is that due to having both the upper hook portion and the lower hook portion, the user can choose to open the door using either the upper hook portion or the lower hook portion depending on the need of the user. Therefore, the present invention is more convenient than conventional door openers.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a dual-purpose foot-operated door opener in accordance with the present invention;

FIG. 2 is a perspective view of the foot-operated door opener in FIG. 1, showing the foot-operated door opener from another angle;

FIG. 3 is a sectional view of the foot-operated door opener in FIG. 1;

FIG. 4 is a side view of the foot-operated door opener in FIG. 1, showing a door can be pulled open using the upper hook portion;

FIG. 5 is a side view of the foot-operated door opener in FIG. 1, showing the door can be pulled open using the lower hook portion;

FIG. 6 is a perspective view of another embodiment of a foot-operated door opener in accordance with the present invention; and

FIG. 7 is a sectional view of the foot-operated door opener in FIG. 6.

### DETAILED DESCRIPTION OF THE PREFERRED EMBODIMENTS

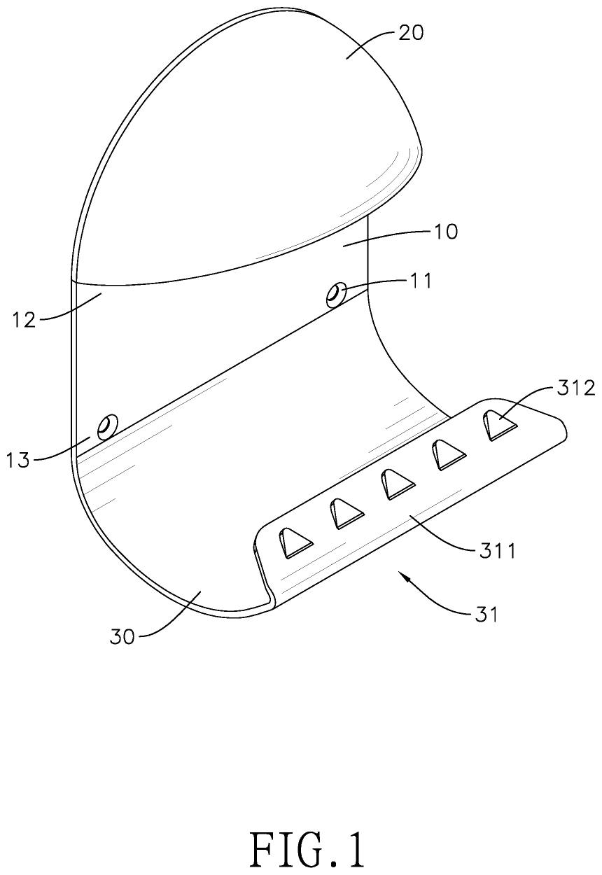

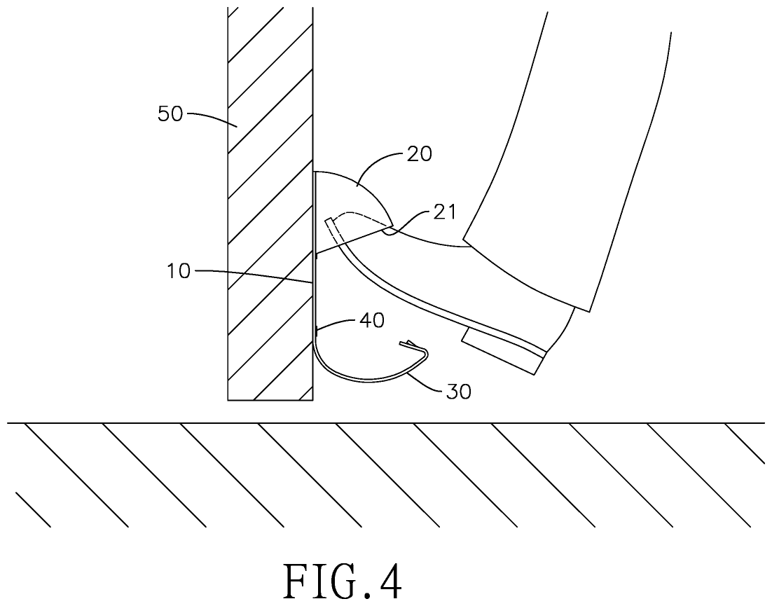

With reference to FIG. 1 and FIG. 4, a dual-purpose foot-operated door opener in accordance with the present invention is adapted to be fixed on an inward surface of a door 50. Said inward surface is defined as the side of the door 50 facing toward a direction in which the door 50 swings open. The foot-operated door opener comprises a fixed portion 10, an upper hook portion 20 and a lower hook portion 30.

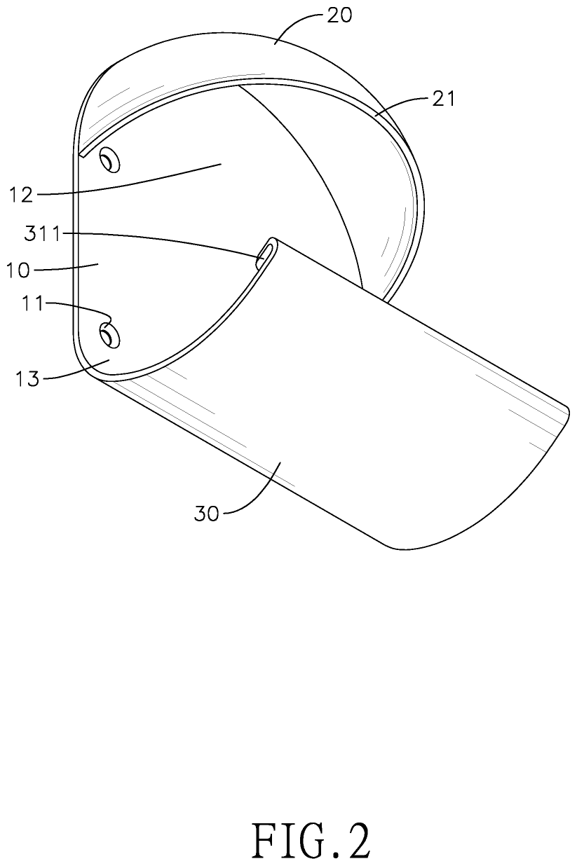

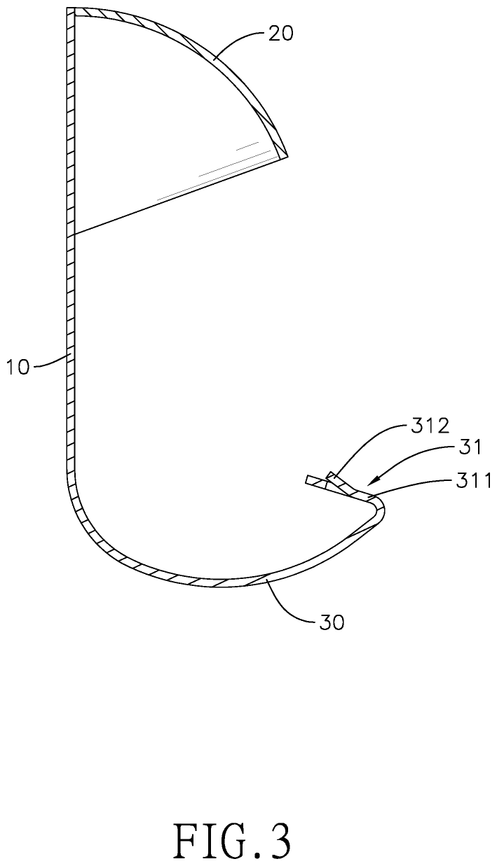

With reference to FIGS. 1 to 3, the fixed portion 10 is a plate and has a mounting hole 11 formed therethrough. In the preferred embodiment, the fixed portion 10 has, but not limited to, an upper end 12 and a lower end 13, but a shape of the fixed portion 10 can be changed as desired as long as it is capable of being fixed to the door 50.

The upper hook portion 20 is connected to the upper end 12 of the fixed portion 10. In the preferred embodiment, the upper hook portion 20 is a cover. The upper hook portion 20 extends away from the door 50 and is bent downward such that the upper hook portion 20 is curved. A bottom edge 21 of the upper hook portion 20 and the fixed portion 10 form an upper hook opening. When viewed laterally, a distance between the bottom edge 21 and the ground gradually increases toward a direction away from the door 50. In another preferred embodiment, the bottom edge 21 can extend horizontally.

The lower hook portion 30 is a plate connected to the lower end 13 of the fixed portion 10, extending away from the door 50 and bent upward. In the preferred embodiment, the lower hook portion 30 and the fixed portion 10 are integrally formed.

The lower hook portion 30 has an anti-slip portion 31 formed thereon. The anti-slip portion 31 has a base plate 311 and multiple anti-slip bumps 312. The base plate 311 is a plate bent toward the fixed portion 10. The anti-slip bumps 312 protrude upward from the base plate 311 and are disposed apart from each other. Each one of the anti-slip bumps 312 is a triangular plate formed by cutting the base plate 311 and then bending the cut area upward. Openings formed by the anti-slip bumps 312 due to said cutting and bending are directed toward the fixed portion 10. Structure of the anti-slip bumps 312 can be changed as desired as long as they prevent slips.

With reference to FIG. 1 and FIG. 4, when installing the present invention, mount at least one fastener 40 through the at least one mounting hole 11 of the fixed portion 10 to fix the fixed portion 10 on the inward surface of the door 50. The fixed portion 10 is preferably located near a bottom edge of the door 50 and a door frame (not shown in figures). The at least one fastener 40 is, but not limited to, a screw.

When in use, the door 50 can be opened in two ways as follows.

The first way is to put the tiptoes of a foot into the upper hook portion 20 via the upper hook opening and abuts instep of the foot against an inner surface of the upper hook portion 20 to hook the upper hook portion 20. Then the user can retract the foot toward his body to pull the door 50 open by the upper hook portion 20.

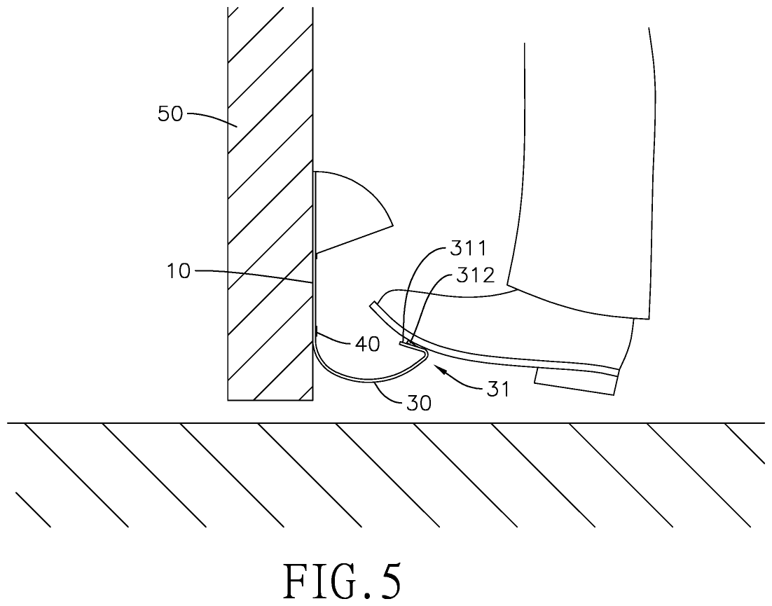

With reference to FIG. 1 and FIG. 5, the second way is to press the sole of the foot on the anti-slip portion 31 of the lower hook portion 30 to frictionally engage the foot with the lower hook portion 30 through pressing force exerted to a protruded end of the anti-slip bumps 312 on the anti-slip portion 31 by the foot. Then the user can retract his foot toward his body to pull the door 50 open using friction between the lower hook portion 30 and the foot.

The present invention is more convenient than conventional door openers due to both the upper hook portion 20 and the lower hook portion 30. The user can open the door 50 in either one of the two ways depending on ease of use. Moreover, the present invention is more ergonomic because the upper hook portion 20 and the lower hook portion 30 are curved to provide more space for the foot to exert force. Curved shape of the upper hook portion 20 prevents slips during pulling.

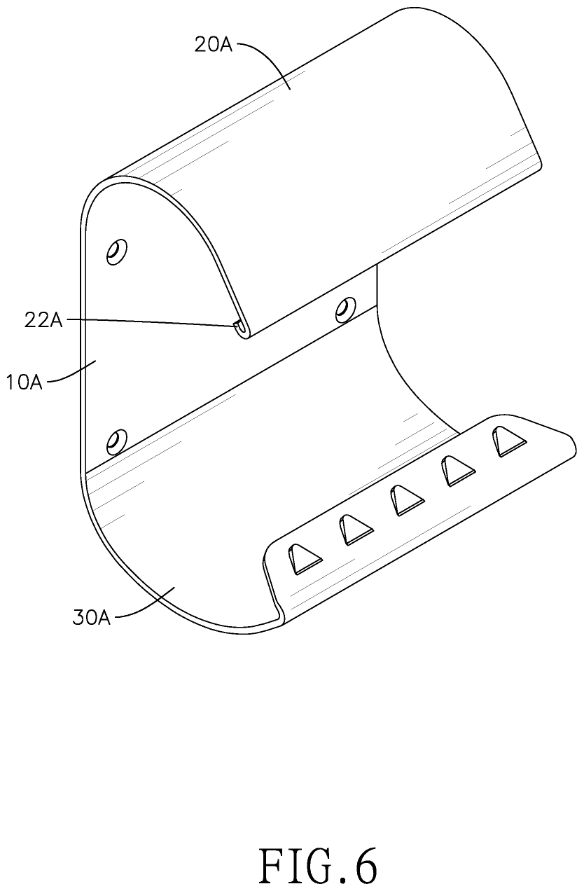

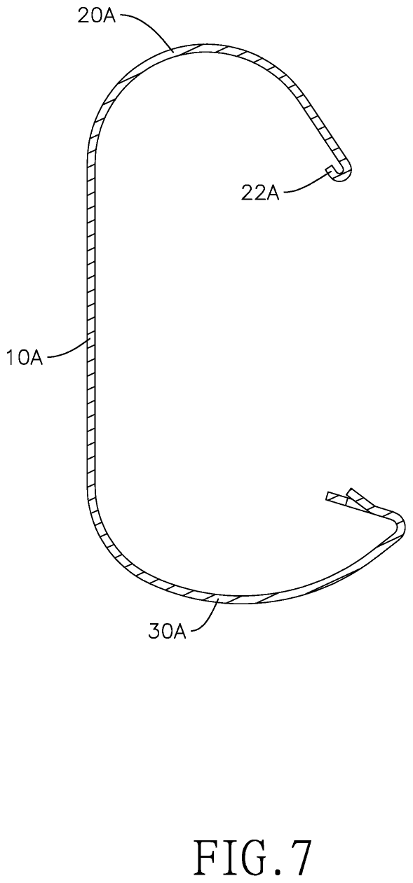

With reference to FIG. 6 and FIG. 7, the fixed portion 10A and the lower hook portion 30A in another embodiment of the present invention are same as in the embodiment aforementioned, but the upper hook portion 20A is a plate integrally formed with the fixed portion 10A and has an inward-folded portion 22A. The inward-folded portion 22A is formed on a bottom edge of the upper hook portion 20A and bent upward. To be precise, the inward-folded portion 22A is bent upward with respect to the rest of the upper hook portion 20A. The upper hook portion 20A forms a U-shape when seen from a sectional view thereof.

In addition to pulling the door 50 open by pressing the sole of the foot on the lower hook portion 30A, the user may also choose to pull the door 50 open using the upper hook portion 20A. To be specific, the user puts the tiptoes of the foot between the fixed portion 10A and the upper hook portion 20A, and then abuts instep of the foot against the inward-folded portion 22A, and finally the user retracts the foot toward his body to pull the door 50 open. The inward-folded portion 22A further prevents slips when pulling and therefore making the present invention more reliable to use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A dual-purpose foot-operated door opener adapted to be fixed on an inward surface of a door; the dual-purpose foot-operated door opener comprising:
a fixed portion fixed on the inward surface of the door and having
an upper end; and
a lower end;
an upper hook portion connected to the upper end of the fixed portion;
a lower hook portion connected to the lower end of the fixed portion, extending away from the door, and bent upward.

2. The dual-purpose foot-operated door opener as claimed in claim 1, wherein the upper hook portion extends away from the door and is bent downward such that the upper hook portion is curved.

3. The dual-purpose foot-operated door opener as claimed in claim 1, wherein the upper hook portion is a cover; a bottom edge of the upper hook potion and the fixed portion form an upper hook opening.

4. The dual-purpose foot-operated door opener as claimed in claim 1, wherein the upper hook portion is a plate and has
an inward-folded portion formed on a bottom edge of the upper hook portion and bent upward.

5. The dual-purpose foot-operated door opener as claimed in claim 1, wherein the lower hook portion is a plate extending away from the door and bent upward such that the lower hook portion is curved.

6. The dual-purpose foot-operated door opener as claimed in claim 1,
wherein the lower hook portion has an anti-slip portion formed thereon.

7. The dual-purpose foot-operated door opener as claimed in claim 6, wherein the anti-slip portion has
a base plate bent toward the fixed portion; and
multiple anti-slip bumps protruding upward from the base plate and disposed apart from each other.

8. The dual-purpose foot-operated door opener as claimed in claim 7, wherein each one of the anti-slip bumps is a triangular plate; a tip of the anti-slip bump is bent upward.

9. The dual-purpose foot-operated door opener as claimed in claim 1, wherein the fixed portion is a plate and has at least one mounting hole formed therethrough.

10. The dual-purpose foot-operated door opener as claimed in claim 9 further comprising at least one fastener; the at least one fastener mounted through the at least one mounting hole and fixed to the door.
